(19) United States
(12) Patent Application Publication
(10) Pub. No.: US 2023/0166809 A1
(43) Pub. Date: Jun. 1, 2023

(54) METHOD AND DEVICE FOR OPERATING AN ELECTRIC BICYCLE

(71) Applicant: Robert Bosch GmbH, Stuttgart (DE)

(72) Inventors: Daniel Baumgaertner, Tuebinger (DE); Ulrich Vollmer, Weilheim (DE)

(21) Appl. No.: 18/058,970

(22) Filed: Nov. 28, 2022

(30) Foreign Application Priority Data
Nov. 30, 2021 (DE) 10 2021 213 542.0

(51) Int. Cl. B62M 6/45

(52) U.S. Cl. CPC B62M 6/45

(57) ABSTRACT

A method for operating an electric bicycle. The method includes: detecting a mechanical load of a component of the bicycle in a load parameter set caused by a drive of the electric bicycle, ascertaining a resultant mechanical load, which results from the mechanical load of the component caused by the drive since a start of the detection of the mechanical load, based on the load parameter set, and limiting a torque provided by the drive when the resultant mechanical load exceeds a limiting value.

### CROSS REFERENCE

The present application claims the benefit under 35 U.S.C. § 119 of German Patent Application No. DE 10 2021 213 542.0 filed on Nov. 30, 2021, which is expressly incorporated herein by reference in its entirety.

### FIELD

The present invention relates to a device and to a method for operating an electric bicycle.

### BACKGROUND INFORMATION

In the development of electric drives for electric bicycles, assumptions are made about an expected load of components. Of particular interest in this case is how long particular torque values will occur during the service life of the drive. These assumptions are summarized in a so-called load spectrum.

Particular elements of the drive such as, for example, the gears, are designed in such a way that they are able to withstand the load described in the load spectrum. Due to the different driving behavior of different users of the electric bicycle, however, the actual load of the drives is very different. For this reason, the service life of the drives differs significantly.

### SUMMARY

A method according to an example embodiment of the present invention for operating an electric bicycle includes a detection of a mechanical load of a component of the bicycle caused by a drive of the electric bicycle in a load parameter set, an ascertainment of a resultant mechanical load, which results from the mechanical load of the component caused by the drive since a start of the ascertainment of the mechanical load, based on the load parameter set, and a limitation of a torque provided by the drive when the resultant mechanical load exceeds a limiting value.

An example embodiment of a device according to the present invention for operating an electric bicycle includes a control unit, which is configured to detect a mechanical load of a component of the bicycle caused by a drive of the electric bicycle in a load parameter set, to ascertain a resultant mechanical load, which results from the mechanical load caused by the drive since a start of the detection of the mechanical load, based on the load parameter set, and to limit a torque provided by the drive when the resultant mechanical load exceeds a limiting value.

The device according to the present invention is configured, in particular, to carry out the method according to the present invention.

According to an example embodiment of the present invention, a detection of a mechanical load of a component of the bicycle caused by a drive of the electric bicycle takes place in a load parameter set. The drive of the electric bicycle in this case is typically formed by an electric motor. The component in this case is, in particular, a drive train of the bicycle or at least a part of a drive train of the bicycle, for example, a gear. The load parameter set is a set of parameters, the number of parameters in the set not being limited. In a simple case, therefore, the load parameter set may thus also include merely one individual parameter. A mechanical load caused by the drive is, in particular, a type of load, which is directly attributable to a force exerted by the drive.

According to an example embodiment of the present invention, an ascertainment of a resultant mechanical load takes place, which results from the mechanical load of the component caused by the drive since a start of the detection of the mechanical load. The ascertainment in this case takes place based on the load parameter set. The resultant mechanical load describes a load, to which the component was exposed over a course of time. A resultant mechanical load results, in particular, in an aging of the component and/or a fatigue of the material of the component. The resultant mechanical load is calculated from the load parameter set. This is therefore possible, since the load parameter set describes the mechanical load of the component over a course of time or at least results from the course of time thereof. When ascertaining the resultant mechanical load, it is possible to resort to such calculation methods, which are typically used when designing components of the bicycle. The start of the detection of the mechanical load, which is utilized for ascertaining the resultant mechanical load, is, in particular, the point in time of a start-up of the drive, of the component, and/or of the bicycle.

According to an example embodiment of the present invention, a limitation of the torque provided by the drive takes place when the resultant mechanical load exceeds a limiting value. In other words, this means that a lower force is exerted by the drive on the drive train in order to protect the components installed therein. This takes place only when the resultant mechanical load has been impacted by the drive to the point that the mechanical load exceeds the limiting value. Prior thereto, no limitation of the torque provided by the drive takes place. The limiting value is a predefined limiting value. The limiting value is preferably selected in such a way that it corresponds to the resultant mechanical load, for which the electric bicycle or the drive train of the electric bicycle has been designed. Thus, the result is that a mechanical load of the component of the electric bicycle is reduced when the component has reached its calculated lifespan. As a result of the lower load of the components of the bicycle due to a provided reduced torque, it is possible to extend the lifespan. When limiting the torque provided by the drive, a maximum torque, which is generated by the drive during a regular operation of the electric bicycle, is reduced.

As a result of the method according to the present invention, a service life of eBike drives is increased, in particular, in the case of drives that are utilized in a very wear-intensive manner, i.e., in which the maximum possible torque is very often retrieved. This occurs when frequently driving at the highest assist level and when the rider him/herself often applies high torques. The present invention ensures that the service life of drives is to a lesser extent a function of user behavior. In drives, which are driven very “aggressively,” the present invention extends the service life, whereas it has no influence in the case of moderate use.

The result of this is that components of the drive are able to be more precisely designed. During “aggressive” use, the risk of a sudden failure of the drive is lower. Instead, the assistance by the drive decreases toward the end of the service life. The user recognizes that the drive “becomes weaker,” i.e., that the end of its service life could soon be reached. The information that the drive has become weaker may be read out by the manufacturer. These drives may then be analyzed and the pieces of information obtained therefrom may be used for design improvement for future product generations.

Preferred refinements of the present invention are disclosed herein.

The mechanical load caused is preferably caused with the aid of a torque provided by the drive and a behavior of the torque is described by the load parameter set. Thus, it is recorded in the load parameter set over an operating time of the electric bicycle in which way a torque has been quantitatively provided by the drive. The torque provided by the drive is the primary force provided by the drive, which results substantially in an aging of the components installed thereon. It is therefore particularly efficient to detect this torque in order to deduce therefrom an aging of the installed parts. The torque is detected preferably with the aid of a torque sensor.

According to an example embodiment of the present invention, it is further advantageous if the load parameter set describes a frequency distribution, a torque range covered by the drive being subdivided into multiple torque intervals and a time period, which describes how long a torque lying within the respective torque interval has been provided by the drive, being stored in the load parameter set for each of the torque intervals. Thus, a degree of a load of the component with associated torque values is described by each torque interval, a profile, which describes to what extent the components of the bicycle have actually been loaded, being recognizable by the plurality of different torque intervals.

If, for example, the frequency distribution indicates that more or longer high torques have been retrieved than comparatively lower torques have been retrieved, then a more rapid aging or fatigue of the component may be deduced. Accordingly, a higher resultant mechanical load is ascertained from the frequency distribution. Thus, a driving behavior of a user may be particularly efficiently deduced and this behavior may be incorporated into the ascertainment of the resultant mechanical load.

According to an example embodiment of the present invention, the torque intervals are preferably of identical size. The torque intervals subdivide the covered torque range, in particular, into torque intervals of 5%, 10% or 20%. By selecting torque intervals of equal size, it is possible to achieve a linear mapping of the torque provided by the drive onto the torque intervals. This is advantageous, in particular, if a total available torque range is subdivided into torque intervals of 5%. This results, for example, in the following torque intervals with the ranges 0% to 5%, 5% to 10%, 10% to 15%, 15% to 20%, . . . , 95% to 100%. For each of the torque intervals, it is stored how long a torque lying within the respective torque interval has been provided in time units by the drive. The corresponding selection of torque intervals of 5%, 10% or 20% means that measuring inaccuracies do not result in a distortion of the measured time periods; however, sufficient curve shapes over the course of the time period are nevertheless able to be read out over the entire torque. In other words, this means that the measuring resolution is selected to be sufficiently high.

According to an example embodiment of the present invention, the load parameter set further preferably describes a frequency, which indicates how often a torque provided by the drive continuously lay above a predefined torque threshold for longer than a predefined time interval. Thus, it is detected, for example, how long a torque has been retrieved by the drive which, for example, is more than 90% of the theoretically retrievable torque. The value of 90% is understood here to be exemplary, since other threshold values may also be selected as a function of corresponding considerations. Thus, time ranges are detected, in which a particularly high load is exerted by the drive on the component. Thus, it is detected how often a particularly high torque has been exerted for a longer period of time. A longer period of time in this case is a period of time that is longer than the predefined time interval. Thus, it is detected, for example, how often a torque of more than 90% of a maximally available torque has been provided for longer than one or two minutes. The more often this is the case, the higher the resultant mechanical load.

The load parameter set further preferably describes a load time, which indicates how long a torque provided by the drive lay above a predefined torque threshold. Thus, it is detected, for example, for how long a torque of more than 90% of a maximum available torque has been provided either at one stretch or altogether over an operating period of the electric bicycle. The longer the time period, the higher the resultant mechanical load.

According to an example embodiment of the present invention, it is further advantageous if the load parameter set includes a temperature parameter, which describes at which temperature a particular torque has been provided by the drive. Thus, it is detected, for example, which temperature in the surroundings or of the component of the electric bicycle existed when a particular torque threshold was exceeded. Very high temperatures result in a more rapid aging of the component. The same applies to very low temperatures. Thus, for example, a weighting of an influence of a retrieved torque on the resultant mechanical load may take place based on the temperature parameter.

The load parameter set may include a plurality of different load parameter sets, which describe different values. Thus, the load parameter set may, for example, include pieces of information regarding a time of an existence of a particular torque and simultaneously the temperature parameter.

The limitation of the torque provided by the drive preferably takes place via a reduction of an assistance factor. The assistance factor is typically used to define a ratio between a rider torque and the torque provided by the drive. The assistance factor in this case is defined, in particular, in the form of a curve, different motor torques being assigned to different rider torques. A rider torque in this case is a torque exerted by a rider. The motor torque in this case is the torque provided by the drive. The limitation of the torque provided by the drive may take place for the entire range or for individual ranges of the curve defining the assistance factor. Thus, the torque is limited, for example, only for an upper range of the curve, via which the maximum rider torques are converted into motor torques. This means that only a peak load of the drive is reduced, however, no limitation takes place during simple pedaling processes in the simple or medium force range.

According to an example embodiment of the present invention, it is further advantageous if the ascertainment of the resultant mechanical load takes place based on the same calculation criteria that have been utilized when designing the electric bicycle. The limiting value is selected, in particular, in such a way that it limits the resultant mechanical load in accordance with the load spectrum. In this way, it may be ensured that a theoretically calculated aging for which the component is designed also corresponds to the aging in which the load is limited by the limitation of the torque provided by the drive. Thus, it may be ensured that the component is not overloaded and fails, before a limitation of the provided torque occurs.

The resultant mechanical load defines, in particular, a load level of the component, which has already been reached since the start of the use of the component at the bicycle. The resultant mechanical load is subdivided, in particular, in a load range of 0% to 100%, 0% defining a new component and 100% defining a component that will most likely shortly fail. The resultant mechanical load increases with the use of the drive and increases over the service life. If a particular limiting value is reached, for example, 90% or 100%, the limitation of the torque provided by the drive takes place.

### BRIEF DESCRIPTION OF THE DRAWINGS

Exemplary embodiments of the present invention are described in detail below with reference to the figures.

FIG. 1 shows a flowchart of a method according to the present invention for operating an electric bicycle in one exemplary specific embodiment of the present invention.

FIG. 2 schematically shows a representation of an electric bicycle including a device for operating the electric bicycle, according to an example embodiment of the present invention.

### DETAILED DESCRIPTION OF EXAMPLE EMBODIMENTS

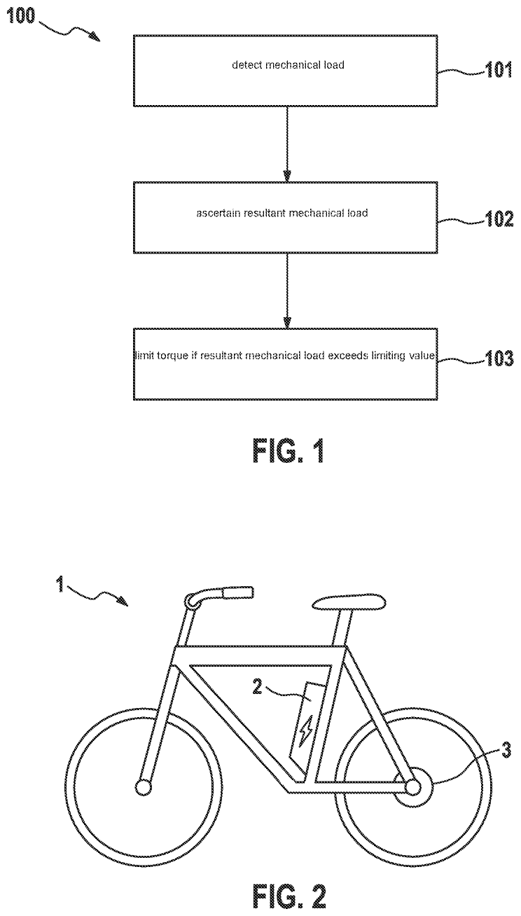

FIG. 1 shows a flowchart of a method 100 for operating an electric bicycle 1. Method 100 includes a first step 101, a second step 102 and a third step 103.

In first step 101, a detection of a mechanical load of a component of bicycle 1 caused by a drive 3 of electric bicycle 1 takes place in a load parameter set. The detection of the mechanical load in the load parameter set takes place starting with a start-up of bicycle 1. For this purpose, method 100 is initiated, for example, during manufacture or during a sale of bicycle 1 by a dealer via a service interface. The component, whose mechanical load is detected in the load parameter set, is, here, for example, a component of a drive train of the bicycle, for example, gears of the bicycle. The gears of bicycle 1 are loaded primarily by a torque caused by drive 3. In order to detect the mechanical load of the component, a behavior of the torque is described by the load parameter set. A behavior of the torque in this case may be recorded in the load parameter set in different ways.

Thus, for example, the load parameter set describes a frequency distribution, a torque range covered by the drive being subdivided into multiple torque intervals and a time period being stored in the load parameter set for each of the torque intervals, which describes how long a torque present within the respective torque interval has been provided by the drive. Thus, the torque range covered by the drive, i.e., a range of 0 Nm up to the maximum available torque, is subdivided, for example, into twenty torque intervals of equal size, which subdivide the entire torque range into 5% intervals. If the electric bicycle and drive 3 are operated, it is then read out which torque is provided by the drive and this is noted for the associated torque interval. If, for example, drive 3 is operated in such a way that the drive provides 3% of the maximum possible torque for one minute, a corresponding time period of one minute is then added up in the interval from 0% to 5%. After a longer operation of the electric bicycle, a frequency distribution will result, from which it is apparent which torque values have been most frequently used. The frequency distribution indicates to what extent the component has been loaded by the torque in the given time period as of the recording of the frequency distribution.

Alternatively or in addition, the load parameter set describes a frequency, which indicates how often a torque provided by drive 3 lay continuously above a predefined torque threshold for longer than a predefined time interval. Thus, the predefined time interval is selected, for example, to be at one minute, two minutes or three minutes. The predefined torque threshold could be selected to be up to 90% of the torque maximally provided by drive 3. This means that once more than 90% of the maximally available torque is retrieved by drive 3 for longer than, for example, one minute, a counter is then incremented. The higher the counter content, the higher the resultant mechanical load of the component.

Alternatively or in addition, a load time is described by the load parameter set, which indicates how long a torque provided by the drive was present above a predefined torque threshold.

Thus, it is detected, for example, when the torque provided by drive 3 was higher than 90% of the maximally available torque. If, during an operation, the torque is above this predefined torque threshold, then a timer is activated, which adds these times together. The higher the summed-up time, the stronger the mechanical load of the component.

Alternatively or in addition, the load parameter set includes a temperature parameter, which describes at which temperature a particular torque has been provided by drive 3. Thus, it is detected, for example, which temperature drive 3 or the components of bicycle 1 exhibit when a particular torque is retrieved. If these temperatures are above or below a particular temperature threshold, this may lead to a particularly high resultant mechanical load.

As previously described, the load parameters in the load parameter set allow for a conclusion to be drawn about a resultant mechanical load of the component of the bicycle. The terms “aging” and “fatigue” and “mechanical load” are cited here in context, since a higher mechanical load typically results in a more rapid aging or fatigue of the component.

In second step 102, an ascertainment of a resultant mechanical load follows, which results from the mechanical load of the component caused by drive 3 since a start of the detection of the mechanical load. This takes place based on the load parameter set. Thus, the values stored in the load parameter set are analyzed and from this a resultant load is deduced. In the process, the time period since the start of the detection of the mechanical load is considered, i.e., typically a time period since an initial start-up of electric bicycle 1 or of drive 3. In very simple specific embodiments, this may take place, for example, by simply considering how high a counter content is, which describes how often the torque provided by the drive was continuously above the predefined torque threshold for longer than the predefined time interval. The counter content may be considered to be an equivalent for the resultant mechanical load. It is noted, however, that typically more complex calculations are used, which are available, in particular, from the field of the mechanical design of components. Thus, when designing mechanical components, it is established which mechanical loads the components must withstand over their lifetime. For this purpose, the mechanical loads, among other things, are defined. These loads also appear in the detected load parameter set. Thus, when ascertaining the resultant mechanical load, a resultant mechanical load, in particular, is ascertained, which is calculated based on the same calculation criteria, which are also utilized during a design of electric bicycle 1.

Thus, when ascertaining the resultant mechanical load, a value is calculated, which describes the load exerted on the component over an operating period of bicycle 1. If the resultant mechanical load exceeds a predefined limiting value, then third step 103 is carried out.

In third step 103, the torque provided by drive 3 is limited if the resultant mechanical load exceeds the limiting value. For this purpose, an assistance factor, in particular, is reduced. The assistance factor indicates the ratio between a rider torque provided by a rider of electric bicycle 1 and the motor torque provided for assistance by drive 3. If the assistance factor is reduced, then, given the same rider torque, a lower torque is provided by drive 3. The assistance factor is defined typically via a curve, which describes a correlation between different rider torques and different drive torques. In order to reduce the assistance factor, a slope of this curve is reduced. Thus, for example, a rider is given 10% less assistance by drive 3 over the entire bandwidth of the rider torque.

FIG. 2 shows electric bicycle 1 including a control unit 2, which is configured to carry out the method described in FIG. 1.

The load of the elements of the drive increases, in particular, with the torque delivered by the drive. For this reason, the delivered torque of drive 3, in particular, is calculated and recorded during the entire operating time.

Various characteristic values are calculated and recorded, for example, the frequency distribution: previous time period, in which 0% to 5%, 5% to 10%, 10% to 15% . . . 95% to 100% of the maximum torque has been delivered; how frequently a torque lays continuously close to the maximum value (for example, 95% to 100%) for longer than 1 minute, 2 minutes, etc., the maximum time period for which a torque >90% has been generated, for which a torque >80% has been generated, etc., and/or in which temperature ranges the torque lies (the higher the temperature, the stronger the load). From these values, a characteristic value for the cumulative load previously seen by the drive is continuously calculated in the control unit, which is also referred to here as the resultant mechanical load. When designing the drive, a value is calculated for this cumulative load, which the drive is able to reliably withstand without becoming functionally unfit (load capacity). When the cumulative load approaches the calculated load capacity, the control of the drive is changed in such a way that less torque is delivered in the future, i.e., so that the drive is no longer so severely loaded. This may occur by reduction of the maximum generated torque or by reduction of the assistance factor.

In addition to the above description, explicit reference is made to the description of FIGS. 1 and 2.

What is claimed is:

1. A method for operating an electric bicycle, comprising the following steps:
detecting a mechanical load of a component of the bicycle in a load parameter set caused by a drive of the electric bicycle;
ascertaining a resultant mechanical load, which results from the mechanical load of the component caused by the drive since a start of the detection of the mechanical load, based on the load parameter set; and
limiting a torque provided by the drive when the resultant mechanical load exceeds a limiting value.

2. The method as recited in claim 1, wherein the caused mechanical load is caused using a torque provided by the drive, and a behavior of the torque is described by the load parameter set.

3. The method as recited in claim 1, wherein the load parameter set describes a frequency distribution, a torque range covered by the drive being subdivided into multiple torque intervals, and a time period, which describes how long a torque lying within the respective torque interval has been provided by the drive, being stored in the load parameter set for each of the torque intervals.

4. The method as recited in claim 3, wherein the torque intervals are identical in size, the covered torque range being subdivided in torque intervals of 5% or 10% or 20%.

5. The method as recited in claim 1, wherein the load parameter set describes a frequency, which indicates how often a torque provided by the drive lay continuously above a predefined torque threshold for longer than a predefined time interval.

6. The method as recited in claim 1, wherein the load parameter set describes a load time, which indicates how long a torque provided by the drive lay above a predefined torque threshold.

7. The method as recited in claim 1, wherein the load parameter set includes a temperature parameter, which describes at which temperature a particular torque has been provided by the drive.

8. The method as recited in claim 1, wherein the limitation of the torque provided by the drive takes place via a reduction of an assistance factor.

9. The method as recited in claim 1, wherein the ascertainment of the resultant mechanical load takes place based on the same calculation criteria that have been utilized when designing the electric bicycle.

10. A device for operating an electric bicycle, comprising:
a control unit configured to:
detect a mechanical load of a component of the bicycle in a load parameter set caused by a drive of the electric bicycle,
ascertain a resultant mechanical load, which results from the mechanical load of the component caused by the drive since a start of the detection of the mechanical load, based on the load parameter set, and
limit a torque provided by the drive when the resultant mechanical load exceeds a limiting value.
